(19) United States
(12) Patent Application Publication
(10) Pub. No.: US 2020/0265997 A1
(43) Pub. Date: Aug. 20, 2020

(54) METAL-POLYMER CAPACITOR COMPRISING A DIELECTRIC FILM WITH HIGH DIELECTRIC CONSTANT AND STRONG BREAKDOWN FIELD

(71) Applicant: COMMISSARIAT A L'ENERGIE ATOMIQUE ET AUX ENERGIES ALTERNATIVES, Paris (FR)

(72) Inventor: Bernard VIALA, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 16/787,071

(22) Filed: Feb. 11, 2020

(30) Foreign Application Priority Data
Feb. 18, 2019 (FR) 1901600

(51) Int. Cl. H01G 4/18; H01G 4/08; H01G 4/10; C08J 5/18; C08L 25/06

(52) U.S. Cl. CPC H01G 4/18; H01G 4/08; H01G 4/10; C08J 5/18; C08L 25/06; C08L 2205/025; C08L 2203/20; C08J 2325/06; C08J 2425/06; C08L 2205/20; C08L 2203/16

(57) ABSTRACT

Metal-polymer capacitor comprising a dielectric film disposed between a first electrode and a second electrode, characterised in that the dielectric film comprises:
core/shell structure nanoparticles, the core of the nanoparticles being metallic and the shell comprising a first layer made of an inorganic carbonaceous material and a second layer made of a first polymer material, the nanoparticles having a narrow size distribution,
a matrix wherein the nanoparticles are dispersed, the matrix being a mineral matrix or a matrix made of a second polymer material.

### TECHNICAL FIELD

The present invention relates to the field of capacitors, and more particularly metal-polymer capacitors, particularly for so-called high-voltage applications.

The invention also relates to a method for manufacturing such a metal-polymer capacitor.

### PRIOR ART

“Metal/Insulator/Metal” (MIM) film type capacitors are structures wherein a dielectric material is wound between two metal electrodes. The dielectric material must be flexible and is, generally, of organic type (impregnated papers, oils and polymers).

Demand for high-voltage capacitors for energy conversion is growing continually with the development of electric vehicles. High-efficiency power conversion modules now require capacitors to meet numerous criteria, in particular the capacitors must:
be connected as close as possible to the circuits, i.e. with the shortest possible connection lengths in order to limit parasitic resistance and inductance,
be extremely thin (<1 mm) in order to be able to be integrated in the modules, for example, disposed plumb with the circuits,
have a high breakdown voltage (≥200 MV/m),
have a high permittivity (≥50),
have low electric losses (<10²),
have a good temperature stability (at least up to 100° C.).

At the present time, it is possible to manufacture very thin polymer films (up to 60 μm) having high breakdown voltages (up to 650 MV/m). The films are, for example made of polystyrene (PS), Polyethylene terephthalate (PET), polytetrafluoroethylene (PTFE), or indeed polyetherimide (PEI).

However, such films have a low intrinsic dielectric constant (at most up to 3.2). The low permittivity of these dielectrics is the barrier to high-voltage capacitor miniaturisation as this means that the surface density of the capacitors is consequently intrinsically limited.

Poly((vinylidene fluoride-trifluoroethylene-chlorofluoroethylene) (P(VDF-TrFE-CFE) and poly((vinylidene fluoride-trifluoroethylene-chlorotrifluoro ethylene) (P(VDF-TrFE-CTFE) terpolymers are exceptions among the dielectric polymers.

Adding non-polar plasticisers (CFE or CTFE) to PVDF induces disorder in the arrangement of the polar chains of the copolymer. The polymer thus acquires a relaxing property (devoid of hysteresis cycles). Furthermore, adding plasticiser lowers the Curie temperature of the copolymer, which results in a very high permittivity for a polymer (that can attain 60). The terpolymer is therefore theoretically capable of storing 5 times more energy under ambient conditions than the ferroelectric co-polymer homologue thereof wherein the permittivity attains 12. The breakdown field of this terpolymer is of the order of 400 MV/m (Chu et al. “A dielectric polymer with high electric energy density and fast discharge speed”, Science, 313(5785), 334-336). These relaxing polar dielectric polymers are generating much interest in power capacitors. Inks or solutions of this polymer currently exist that can be deposited in thin layers (1 to 10 μm) by screen printing or spin coating on thin substrates (PEN, silicon, glass).

However, the low Curie temperature induces a significant variation of the dielectric properties with the temperature, which may be penalising for power applications that emit large amounts of heat. However, above all, converting the piezoelectric effect of the copolymer (proportional to V) into an electrostrictive effect with the terpolymer (proportional to V²) poses a problem as it induces greater mechanical compression of the polymer at high voltage. By being compressed between the electrodes, the capacitor then undergoes a catastrophic increase in the internal electric field (avalanche effect) which causes the destruction thereof. It is therefore difficult to use this polymer at high voltage.

Part of the scientific community has therefore turned to nanocomposite materials to increase the permittivity of the polymers by adding either oxide nanoparticles or metallic nanoparticles.

The first process consists of adding oxide nanoparticles in a polymer. More particularly, the polymer is mixed with a high concentration of nanoparticles of high-permittivity complex oxides (TiO₂, SrTiO₃, BaTiO₃, PZT, PMNPT, etc.). The mixtures are prepared in homogeneous medium using simple techniques, with stirring. The increase in the permittivity only becomes substantial for high load rates according to the mixing law (Maxwell Garnet), for example for load rates greater than 30% or 50% by mass. However, with such mass concentrations, the nanocomposite material formed is subject to significant inhomogeneities of the local electric field at the interface between the high-permittivity nanoparticles and the low-permittivity polymer. However, these permittivity contrasts give rise to an increase in the electric field on the lowest permittivity end, i.e. herein on the polymer end. The latter is therefore subject to a greater electric field. It will therefore be caused to breakdown prematurely in the zones where the polymer is thinner. Such nanocomposites highly charged with high-permittivity nanoparticles are therefore not suitable for high voltage. Furthermore, the quantity of polymer present between the nanoparticles is variable and poorly controlled.

The second process consists of mixing the polymer with low concentrations of electrically conductive nanoparticles, for example metallic nanoparticles. This is referred to as a metal-polymer composite or conductor-dielectric composite. In such a medium, the concentration of the metallic or conductive phase must remain below the electrical percolation threshold which generally is low (generally less than 1% by volume), and be controlled with great precision. The conditions are then created for the formation of a giant permittivity at the metal-dielectric interface according to Bruggeman's theory represented in FIG. 1 and by the following equation:

$$ɛ = {ϵ}_{pol} \times \frac{1}{( {f}_{c} - f )}$$

It is then possible, for low load rates, to increase the permittivity of the composite material significantly (by more than one order of magnitude) with respect to the permittivity of the host polymer.

However, these composite materials are obtained by mixing the different constituents in homogeneous medium using simple techniques with stirring. However, the dispersion of the metallic nanoparticles is generally poorly controlled in a polymer.

A significant improvement was proposed in the article by Shen et al. (“High dielectric performance of polymer composite films induced by a percolating interparticle barrier layer”, Advanced Materials 2007, 19(10), 1418-1422). It was demonstrated that grafting a thin layer of polymer 1 (PVP) around silver nanoparticles 2 before mixing same with a host polymer 3, of epoxy type, resulted in superior nanoparticle dispersion as the polymer shell acts as a spacer. The diameter of the silver core ranges from 20 to 120 nm and the thickness of the shell is 4-6 nm for the thinnest shells and 8-10 nm for the thickest shells. The permittivity of this composite material attains about 300 at the percolation threshold (0.2% vol.). Such a dielectric film is represented schematically in FIG. 2. However, the voltage strength of this composite material falls from 10 MV/m to 1 MV/m before the percolation threshold.

The breakdown strength may be enhanced by adding hexagonal boron nitride nanoplates. Thus, in the article by Wu et al. (“Graphene/Boron Nitride-Polyurethane Microlaminates for Exceptional Dielectric Properties and High Energy Densities”, ACS applied materials & interfaces 2018, 10(31), 26641-26652), the breakdown strength of a reduced graphene oxide rGO aerogel (conductive phase) mixed with polyurethane (dielectric phase) is enhanced by inserting, between the layers of aerogel layers, nanoplates of hexagonal boron nitride coated in polyurethane. The forming of such a microlaminate composite uses freeze casting and pressing, which is not compatible with numerous substrates, and particularly with silicon technologies, and is not suitable for producing an integrated capacitor.

### DESCRIPTION OF THE INVENTION

An aim of the present invention is that of providing a capacitor having a high permittivity, low losses due to conduction and a good electrical voltage strength.

For this, the present invention relates to a metal-polymer capacitor comprising a dielectric film disposed between two electrodes, the dielectric film comprising:
core-shell structure nanoparticles, the core of the nanoparticles being metallic and the shell comprising a first layer made of an inorganic carbonaceous material and a second layer made of a first polymer material, the ratio between the maximum nanoparticle diameter and the minimum nanoparticle diameter being less than or equal to 5, preferably less than or equal to 3,
a mineral matrix or matrix made of a second polymer material, wherein the nanoparticles are dispersed.

The nanoparticles represent from 0.01% to 10%, preferably from 0.01% to 5% and even more preferentially from 0.1% to 2% by volume of the dielectric film. The core/shell structure nanoparticles represent a volume fraction of the dielectric film below the electrical percolation threshold of the dielectric film.

The invention differs fundamentally from the prior art, in particular, by the presence of monodispersed metal/polymer hybrid nanoparticles.

The narrow size distribution of the nanoparticles, coated with the first polymer material, makes it possible to limit or even suppress interparticle conduction: both low-voltage direct conduction paths (local ohmic effect due to the absence of polymer locally) and high-voltage indirect conduction paths (field effect (FET) or tunnel effect via very thin polymer barriers), which increases permittivity, results in a decrease in losses due to conduction and prevents having uncontrolled breakdown fields.

In the dielectric film, the absence of aggregates and very large nanoparticles (for example having a larger size, or larger dimension, up to 100 times, 30 times or 10 times larger than the mean nanoparticle size) and the absence of very small nanoparticles (having a size, for example up to 6 times or 10 times smaller than the mean nanoparticle size) are observed.

Advantageously, the nanoparticles are dispersed homogeneously in the polymeric matrix. Dispersed homogeneously denotes that the nanoparticles are distributed substantially uniformly in the polymeric matrix. This makes it possible to reduce interparticle conduction all the more.

This homogeneous dispersion is enabled by the presence of the second layer made of a polymer material in the shell which coats the nanoparticles. The second polymer layer covers at least partially and, preferably, fully the core of the nanoparticles. In addition to reducing the probability of interparticle conduction, it may act as a spacer, according to the quantity of nanoparticles in the dielectric film. The thickness may, for example, range from 5 to 15 nm. It has, advantageously, a uniform thickness around the nanoparticle. Advantageously, the thickness of the layer of second material is substantially identical from one nanoparticle to another. Substantially identical means that the thickness does not vary by more than 20% from one nanoparticle to another and within the same nanoparticle.

The presence of the layer of inorganic carbonaceous material makes it possible to graft the layer of polymer material covalently around nanoparticles. The core of the nanoparticles is protected from oxidation by the shell, which enables same to retain the initial properties thereof (for example magnetic and/or electrical). Furthermore, the mechanical stability of the nanoparticles over time is enhanced.

Advantageously, the inorganic carbonaceous material is organized 2D carbon. Preferably, the carbonaceous material is graphene. The carbonaceous layer is formed from a repetition of some layers to some tens of layers of graphene to retain a 2D organised carbon structure. For example, it comprises some layers of graphene (from 2 to 5 for example). Advantageously, a carbonaceous layer comprising at least two layers of graphene will be chosen to give the nanoparticle sufficient hydrophilic properties and to be able to form Van der Waals bonds. Advantageously, a number of layers less than 100 will be chosen, to prevent the appearance of defects in the layers and have a disorganised 2D carbon arrangement on the surface, for example hydrogenated, or of graphitic type which are hydrophobic.

The carbonaceous layer forms, advantageously, a continuous layer around each nanoparticle.

Advantageously, the core of the nanoparticles is made of cobalt, iron, nickel, copper, gold and/or silver.

Advantageously, the first polymer material is chosen among polystyrene, poly(methyl methacrylate), polyurethane, a polyacrylic, polypropylene, a polyimide, polyetherimide and a polymer having a pyrene group.

Advantageously, the dielectric film comprises electrically insulating nanoparticles. Indeed, in the presence of a strong electric field, a low-intensity current may be established between the nanoparticles due to a tunnel effect (FET). At low voltage, this does not pose a problem. However, on increasing the voltage beyond a certain threshold, these currents increase suddenly and the current density in the host polymer becomes problematic. At high voltage, the emission of electrons due to a field effect at the metal/polymer interface may induce an increase in the electrical losses and/or a temperature rise which may soften or even melt the coating polymer and/or the host polymer causing the destruction of the composite material and the capacitor. The insertion of electrically insulating nanoparticles makes it possible to limit or even suppress undesirable electrical phenomena. The capacitor obtained has a high dielectric constant and a strong breakdown field.

Furthermore, it is possible, even for high-voltage applications, to choose polymers wherein the melting point or glass transition temperature is relatively low (less than or equal to 150° C. for example), which makes it possible to use a wide choice of polymers.

Advantageously, the electrically insulating nanoparticles are made of metal oxide, for example of barium and/or strontium oxide.

Even more advantageously, the electrically insulating nanoparticles are made of a semiconductor material, preferably wide-bandgap, such as silicon carbide, diamond and/or hexagonal boron nitride. In the case of hexagonal boron nitride, it may also consist of nanotubes and/or nanoplates.

According to a first alternative embodiment, the electrically insulating nanoparticles are in the shell of the nanoparticles.

According to a second alternative embodiment, suitable for being combined with the first alternative embodiment, the electrically insulating nanoparticles are in the polymeric matrix.

The dielectric film may comprise an alternation of core/shell structure nanoparticles and electrically insulating nanoparticles.

The core/shell structure nanoparticles and the electrically insulating nanoparticles may be dispersed randomly in the matrix.

Advantageously, the second polymer material is chosen among polystyrene, polyethylene terephthalate, cellulose acetate, polycarbonate, polypropylene, polyethylene, a polyamide, a polysiloxane, a polysulphone, an optionally aromatic polyester, a polyetheretherketone, a polyetherimide and an epoxide.

Advantageously, the second polymer material comprises groups photosensitive to ultraviolet rays.

Advantageously, the ratio between the maximum nanoparticle diameter and the minimum nanoparticle diameter is less than 1.5, preferably less than 1.3, even more preferentially less than 1.2 and even more preferentially less than 1.1. Such a very narrow size distribution provides a substantial increase in permittivity.

The invention also relates to a method for manufacturing a metal-polymer capacitor as described above, comprising the following steps:

i. Providing a solution containing:
a solvent,
the core/shell structure nanoparticles, the core of the nanoparticles being metallic and the shell comprising a first layer made of a carbonaceous material and a second layer made of a first polymer material,
the dissolved second polymer material or the precursors of the second polymer material,

ii. optionally, polymerising the precursors of the second polymer material,

iii. depositing the solution on an electrode.

Advantageously, a deposition temperature below the melting point of the first polymer material will be chosen.

Advantageously, the core/shell structure nanoparticles provided in step i) are obtained according to the following steps:

a) Preparing a water-in-oil miniemulsion comprising droplets of an aqueous phase, dispersed in an organic phase,

b) Adding nanoparticles comprising a metallic core coated with a shell of carbonaceous material, whereby nanoparticles trapped in the droplets are obtained,

c) Adding precursor monomers of the first polymer material, and

d) Adding a polymerisation initiator,

adding the monomers and the polymerisation initiator resulting in polymerisation of the monomers, whereby nanoparticles, coated with a layer of the first polymer material, dispersed in the organic phase, are obtained.

Emulsion denotes a heterogeneous mixture of two non-miscible liquids, such as oil and water. One of the two phases (so-called dispersed phase, herein the aqueous phase) is dispersed in droplet form in the other (so-called dispersing phase). The size of the droplets may range from some tens of nanometres to 1 micron, for example from 20 nm to 1 μm. Miniemulsion denotes that the size of the droplets may range from 30 nm to 100 nm, and more preferentially from 30 nm to 60 nm.

The droplets of the miniemulsion form polymerisation reactors. During the polymerisation reaction, the monomers will be progressively consumed until the micelle is saturated. This is referred to as micellar growth. The size of the final particle formed is similar to that of the micelle. In the end, a product referred to as latex is obtained, comprising monodispersed polymer beads (micelles without metallic nanoparticle) and metal-polymer hybrid nanoparticles (micelles with metallic nanoparticles).

This polymerisation in heterogeneous medium results in superior control of the polymer thickness coating the core of the nanoparticles, with respect to polymerisation in homogeneous medium.

The presence of the layer of carbonaceous material surrounding the nanoparticles makes it possible to render the nanoparticles hydrophilic, which enables the insertion thereof into the droplets of the emulsion. The layer of carbonaceous material also protects them effectively against oxidation. Without this carbonaceous shell, the metallic nanoparticles would oxidise spontaneously in contact with water and/or form metal hydroxides, which would render same hydrophobic and contribute to them being expelled from the micelles to join the dispersing phase (oil).

The droplets, in addition, to acting as a polymerisation reactor, act as a filter.

Only nanoparticles wherein the diameter is less than the diameter of the droplets will be trapped in the droplets and coated with a layer of polymer during the method.

Nanoparticles wherein the diameter is greater than or equal to those of the droplets will form a raw sediment (with no polymer) which will be readily subsequently removed. Moreover, it has been observed that the smallest nanoparticles (for example of a diameter of less than 10 nm) are imperfectly coated with the carbonaceous layer and are oxidised rapidly (formation of carboxyls and/or metal oxide), giving them a more hydrophobic nature than nanoparticles fully coated with a carbonaceous layer. These particles do not enter the droplets containing the aqueous phase, remain suspended in the dispersing phase and can be readily subsequently removed.

Nanoparticles with a very narrow size distribution are thus obtained. Advantageously, the ratio between the maximum nanoparticle diameter and the minimum nanoparticle diameter is less than 1.5, preferably less than 1.3, even more preferentially less than 1.2 and even more preferentially less than 1.1. Such a very narrow size distribution is not commercially available and is enabled by the miniemulsion method.

According to a first alternative embodiment, electrically insulating nanoparticles as defined above are added during step i).

According to an alternative embodiment suitable for being combined with the first alternative embodiment, electrically insulating nanoparticles as defined above are added during step a), b) or c).

Further features and advantages of the invention will emerge from the following supplementary description.

Obviously, this supplementary description is merely given by way of illustration of the subject matter of the invention and should in no way be interpreted as a restriction of this subject matter.

### BRIEF DESCRIPTION OF THE DRAWINGS

The present invention will be understood more clearly on reading the description of embodiment examples given merely by way of indication and not restriction with reference to the appended drawings wherein:

FIG. 1, previously described in the prior art, represents, schematically, the progression of the real part ε′ and the imaginary part ε″ of the permittivity E in percolative medium, according to Bruggeman's model,

FIG. 2, previously described, represents, schematically, a dielectric film according to the prior art,

FIGS. 3, 4 and 5 represent, schematically, a sectional view, of planar capacitors according to various particular embodiments of the invention; the inserts schematically represent the field-effect emission of the nanoparticles in the dielectric film.

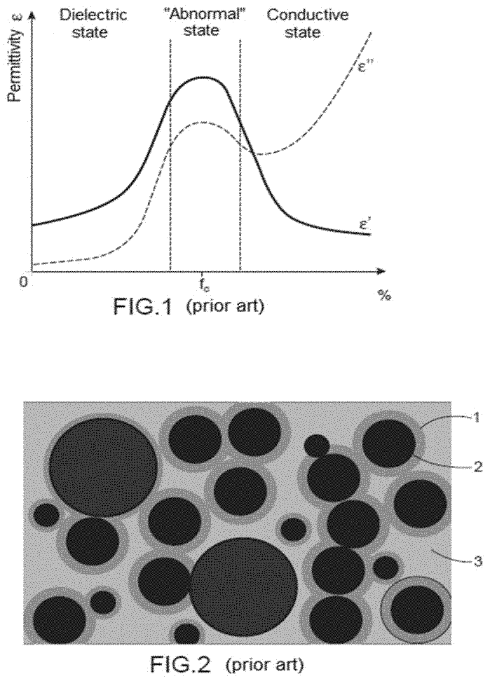

The different parts represented in the figures are not necessarily represented according to a uniform scale, to render the figures more legible.

The different possibilities (alternative embodiments and embodiments) should be understood as not being mutually exclusive and may be combined with one another.

### Detailed Description of Particular Embodiments

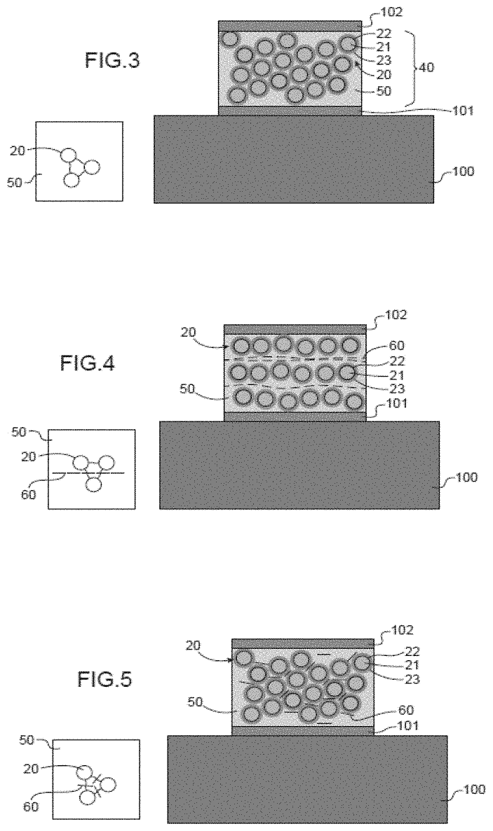

Reference is made to FIGS. 3 to 5 which represent planar capacitors according to various embodiments of the invention.

The figures are not to scale to better represent an overall view of the nanoparticles, particularly in the case where the volume percentage of nanoparticles is relatively low.

The metal/polymer hybrid capacitor is formed on a substrate 100. The substrate 100 is, preferably, made of silicon. Further substrates may be used such as glass, alumina, ferrite and polymer films such as for example polyimide (such as Kapton), polyethylene naphthalate (PEN), and polyethylene terephthalate (PET).

The capacitor comprises a first so-called bottom electrode 101, in contact with the substrate 100 and a second so-called top electrode 102.

The electrodes are electrically conductive and, preferably, made of metal. They are, for example, made of gold.

A dielectric film 40 is disposed between the first electrode 101 and the second electrode 102. The dielectric film comprises a polymeric matrix 50 wherein metal-polymer hybrid nanoparticles 20 are dispersed.

Nanoparticles 20 denote elements of submicronic size (typically less than 1 μm) of spherical, elongated, ovoid shape, for example. Preferably, they consist of spherical particles. The greatest dimension thereof is referred to as diameter or size.

The nanoparticles 20 are monodispersed, i.e. they have a narrow size distribution. In other words, they have a size distribution between a maximum diameter and a minimum diameter such that the ratio thereof is less than or equal to 5, 3 or 2 and advantageously less than or equal to 1.5 for example 1.3 or 1.2 or 1.1. The characteristics of such a powder (ratio 1.1) are, for example, a mean nanoparticle diameter of 40 nm, a maximum diameter of 42 nm and a minimum diameter of 38 nm. The diameter of the nanoparticles 20 may be measured with a laser granulometer or by dynamic light scattering (DLS) in solution.

All the dimensional characteristics mentioned above and hereinafter may also be measured using the following techniques: SEM (scanning electron microscope) and TEM (transmission electron microscope), ellipsometry and spectrophotometry.

Furthermore, as the nanoparticles are solidly coated with an even thin layer of dielectric polymer, the separating distance between the nanoparticles is controlled. For example, the edge-to-edge separating distance between two metal/C particles of diameter ϕ is 1×ϕ, ½×ϕ or ⅔×ϕ and advantageously less than or equal to ⅓×ϕ. For example, such a film is characterised by a homogeneous dispersion of Co/C nanoparticles of mean diameter 30 nm with a mean intergranular distance of 10 nm, up to 5 nm.

The particles 20 have a core-shell structure. The shell 22 is firmly bonded to the core 21 of the particle.

The core 21, or kernel, is a metallic material. Metallic material denotes a metal, a metal alloy. Preferably, it consists of a metal. Preferably, it consists of cobalt, nickel, iron, copper, silver or gold.

The core 21 is coated with a coating 22 or shell. The coating 22 comprises:
a first layer made of a carbonaceous material,
a second layer made of a first polymer material.

Such nanoparticles are annotated as metal/C/polymer.

The carbonaceous material is, preferably, inorganic, for example made of graphene, graphite or carbon nanotubes.

As a general rule, it consists of an organised 2D carbon coating on a non-planar surface (for example on the surface of a nanoparticle).

Preferably, the coating 22 is made of graphene. It may comprise one layer or a plurality (two, three, four, etc.) layers of graphene. For example, it comprises from 1 to 50 lamellae of graphene, preferably from 1 to 10, for example from 1 to 5, and even more preferentially from 3 to 10.

Preferably, the carbonaceous shell 22 is continuous so as to fully cover the core 21 of the particle 20 to protect the core of the nanoparticles from oxidation, and render same more hydrophilic.

Advantageously, the first polymer material is chosen among polystyrene (PS), poly(methyl methacrylate) (PMMA), polyurethane (PU), a polyacrylic (PAA), a polyimide (PI), polyetherimide (PEI) and polypropylene (PP). The polymer may also be a polymer functionalised by a conjugated pi group, such as pyrene. It consists, for example, of polystyrene functionalised by a pyrene group (Py-PS) or indeed a polyacrylic functionalised by a pyrene group (Py-PAA).

The thickness of the layer of polymer 23 ranges, for example, from 1 nm to 100n, preferably from 2 nm to 50 nm, and even more preferentially from 5 nm to 15 nm.

Advantageously, the layer of polymer 23 completely coats the core 21 of the nanoparticle 20.

The polymer material is bonded covalently to the carbonaceous layer, which reduces the risks of decohesion and lamination. The uniformity and adhesion of the electrical insulation layer surrounding the nanoparticles are enhanced. Low-voltage interparticle electrical conduction is suppressed.

As the nanoparticles 20 are solidly coated with an even thin layer 23 of dielectric polymer, the separating distance between the nanoparticles, in the dielectric film, is controlled.

The volume percentage of nanoparticles in the composite material ranges from 0.01% to 10%. Advantageously, to form a capacitor, the volume percentage ranges for example from 0.01% to 5%, and preferably from 0.1% to 2%.

Advantageously, the volume percentage of nanoparticles 20 will be chosen so as to be situated below the electrical percolation threshold, for example, within a range of one quarter to half of the percolation threshold.

The capacitor may comprise one or a plurality of types of nanoparticles 20.

According to a first advantageous alternative embodiment, the matrix 50 is made of a second polymer material.

The second polymer material may be made of polystyrene (PS), polyethylene terephthalate (PET), cellulose acetate (CA), polycarbonate (PC), polytetrafluoroethylene (PTFE), polyparylene, polypropylene (PP), polyethylene (PE), for example cross-linked polyethylene (PEX), polyphenylene sulphide (PPS), biaxially-oriented polypropylene (BOPP), polyimide (PI), polyamide (PA), polysiloxane (or Silicone), polysulphone, an optionally aromatic polyester, for example fluorene polyester (FPE), polyetheretherketone (PEEK), polyetherimide (PEI) and an epoxide (epoxy).

The polymer matrix, for example made of PI and epoxide, may contain photosensitive cross-linking agents, preferably to UV.

The first polymer material and the second polymer material may be identical or different. When the two polymer materials are identical, they have different molecular weights. They may be differentiated, for example by Fourier Transform Infrared spectroscopy (or FTIR).

According to a second advantageous alternative embodiment, the polymeric matrix 50 may be replaced by a silica, alumina, silicon nitride, silicon oxynitride matrix. These matrixes may be deposited by atomic layer deposition (ALD), physical vapour deposition (PVD) or plasma-enhanced chemical vapour deposition (PECVD) at low temperature, for example at a temperature less than 350° C.

The dielectric film 40 has a thickness ranging from 0.05 μm to 50 m.

The capacitor as represented in FIG. 3 is, advantageously, intended for low- or medium-voltage applications. Such a capacitor targets, in particular, a breakdown field of the order of 100 MV/m.

Advantageously, for so-called high-voltage applications (500 MV/m), the dielectric film 40 further comprises electrically insulating nanoparticles 60 (FIGS. 4 and 5). Electrically insulating denotes an intrinsic electrical resistivity greater than 1012 ohm·cm.

Indeed, field-effect emission of electrons at the metal/polymer interface induces, with a strong field, an increase in the electrical losses and a temperature rise which is liable to destroy the capacitor. The circulation of these electrons is, advantageously, blocked by the electrically insulating nanoparticles 60 which form 2D (therefore very thin) insulating “barriers”. The electrically insulating nanoparticles 60 are disposed across the conduction paths (insert of FIGS. 4 and 5). Electrical losses are reduced.

They may consist of mineral nanoparticles, for example silica nanoparticles, nanoparticles of complex oxides, for example of barium titanate (BaTiO₃) or/and strontium titanate (SrTiO₃), diamond or silicon carbide (SiC) nanoparticles.

They may consist of tubular or lamellar nanoparticles. Tubular or lamellar nanoparticles denote particles wherein one of the dimensions is substantially less than the two others. Such tubular or lamellar particles most frequently have a thickness e (or a diameter d) substantially less than the length L or width I thereof. Preferably, the ratio e/L (or d/L) and e/I (or d/I) is less than or equal to 0.5 and preferably less than or equal to 0.1 or 0.01.

Advantageously, the tubular or lamellar nanoparticles are made of hexagonal boron nitride (h-BN). They may also consist of graphene oxide GO.

The lamellar nanoparticles, particularly the h-BN and GO nanoparticles, may, for example, be exfoliated. Exfoliated denotes that lamellae or sheets of the stack forming the lamellar nanoparticles are removed so as to obtain lamellar particles formed from one or a few sheets (2, 3, 4 or 5 for example). Ultrasound exfoliation (sonication) may produce large quantities.

The h-BN tubular particles may, for example, be produced in large quantities by spray pyrolysis.

According to a first embodiment, the dielectric film comprises an alternation of strata of hybrid nanoparticles 20 and strata of electrically insulating nanoparticles 60 (FIG. 4).

According to a second embodiment, represented in FIG. 5, the hybrid nanoparticles and the electrically insulating nanoparticles are dispersed randomly in the polymeric matrix.

According to a further embodiment, the electrically insulating nanoparticles 60 are disposed in and/or on the shell of the hybrid nanoparticles 20.

The latter embodiment may be combined with the first or the second embodiment. In particular, it is possible to have electrically insulating nanoparticles 60 dispersed randomly in the polymeric matrix 50 and in the shell of the hybrid nanoparticles 20.

Such a nanocomposite dielectric film 40 has a high resistivity (for example 10¹²-10¹⁵ μOhm·cm), a dielectric constant that may be exceptionally high (for example 100 or 1000) on approaching the electrical percolation threshold (for example 0.5, 1, or 2% by weight) and a high electrical breakdown strength (for example 10 MV/m, 100 MV/m, 500 MV/m).

The hybrid nanoparticles 20 are electrically insulated, have a narrow size distribution and are dispersed homogeneously in the dielectric film. With such nanoparticles 20, it is possible to miniaturise capacitors intended for high-voltage applications.

Such a capacitor may be used for the integration of power conversion modules, for example for electric vehicles.

The dielectric film 40 may be manufactured, for example, with a method including the following steps:

i. Providing a solution containing:
a solvent,
the core/shell structure nanoparticles 20, the core 21 of the nanoparticles being metallic and the shell comprising a first layer 22 made of a carbonaceous material and a second layer 23 made of a first polymer material, the nanoparticles 20 having a low polydispersity,
the dissolved second polymer material or the precursors of the second polymer material,

ii. depositing the solution on an electrode,

iii. optionally, polymerising the precursors of the second polymer material.

Polymer precursor denotes monomers and/or oligomers and/or pre-polymers leading to the formation of the polymer. The polymer precursor is associated with a polymerisation initiator. The polymerisation initiator is, for example, a photoinitiator or a radical initiator. After forming, the precursor is polymerised so as to obtain the polymer.

The solvent is an organic solvent. The solvent is evaporated after depositing the solution. The solution may be deposited using a non-contact deposition technique. This may consist, for example of a coating technique, such as curtain coating or flow-coating, or dip-coating, or indeed spin-coating. Preferably, it consists of spin-coating.

The film may be exposed to a light source, preferably to an ultraviolet (UV) source. The film may be hot-pressed, preferably in the vicinity of the glass transition temperature.

The solution from step i) may also contain electrically insulating nanoparticles 60 as described above.

Alternatively, it is possible to successively deposit the solution containing the hybrid nanoparticles 20 followed by a second solution containing the electrically insulating nanoparticles 60. This second solution may also contain a third polymer material or the precursors of the third polymer material. The third polymer material is, preferably, identical to the second polymer material. The two solutions may be deposited in alternation until the desired number of strata is obtained.

The method may be carried out at ambient temperature (20-25° C.).

The method is carried out at ambient pressure (1 bar).

The method is, advantageously, carried out in air, there is no need to work in a controlled atmosphere.

Alternatively, the dielectric film 40 may be obtained by plasma deposition. A deposition technique wherein the temperature used is less than the melting point of the polymer material of the shell will advantageously be chosen.

The core/shell structure nanoparticles 20 provided in step i) are, advantageously, obtained according to the following steps:

Preparing a water-in-oil miniemulsion comprising droplets of an aqueous phase, dispersed in an organic phase,

a) Adding nanoparticles 20 comprising a metallic core 21 coated with a shell of carbonaceous material 22, whereby nanoparticles 20 trapped in the droplets are obtained,

b) Adding precursor monomers of the first polymer material, and

c) Adding a polymerisation initiator,

Contacting the monomers and the polymerisation initiator resulting in polymerisation of the monomers, whereby nanoparticles 20, coated with a layer of the first polymer material 23, dispersed in the organic phase, are obtained.

The emulsion will make it possible to sort these nanoparticles 20 according to the size thereof. For example, for a powder wherein the mean diameter of the nanoparticles 20 is of the order of 30 nm, the size dispersion is wide and can range from less than 5 nm to more than 300 nm. This is detrimental for the manufacture of a nanocomposite material with controlled properties. The emulsion acts as a filter. The nanoparticles of a certain size are selected by choosing the micelle size suitably.

Preferably, the size of the micelles is 2 to 3 times greater than the mean size of the nanoparticles 20 (for example between 60 and 90 nm for 30 nm). Only the nanoparticles 20 of mean size of the order of 30 nm will be trapped in the emulsion and only these nanoparticles 20 will be subsequently coated with a layer of polymer 23. In this way, the largest nanoparticles 20 (for example 100 nm or 300 nm) will form a sediment not coated with polymer which will be readily subsequently removed. The smallest nanoparticles 20 (for example of 10 nm and less) imperfectly coated with carbonaceous coating 22 are oxidised rapidly, and therefore more hydrophobic, remain in the organic phase. The nanoparticles suspended in the organic phase or in the sediment, are not involved in polymerisation.

Advantageously, a micelle contains a single nanoparticle 20.

The size of the droplets will be chosen according to the size of the nanoparticles 20 and the thickness of the layer of polymer 23 sought.

During step a), an aqueous phase and an organic phase are contacted so as to obtain a biphasic mixture, then an emulsification of the biphasic mixture in the presence of a surfactant (or emulsifier) is carried out, whereby a water-in-oil emulsion, formed of droplets of the aqueous phase dispersed in the organic phase, is obtained. The droplets form micelles (hydrophilic core-hydrophobic tails).

The emulsification is, for example, formed by stirring (sonication). The mixture remains stable thanks to the addition of emulsifier. The velocity or evolution kinetics of the mixture is quasi-nil, which makes it a confined reaction medium that is particularly stable and favourable for polymer synthesis by monomer polymerisation.

The emulsion may contain further, non-reactive, ingredients, but necessary for emulsion stabilisation.

Advantageously, the electrically insulating nanoparticles are added to the emulsion in step a). The particles are, advantageously, hydrophobic so as to be dispersed in the organic phase with the monomers. During polymerisation, some of these electrically insulating nanoparticles are carried by the monomers and find themselves trapped in and/or on the polymer layer coating the metallic nanoparticle.

In the emulsion, formed in step b), the polymerisation initiator and the monomers, precursors of the polymer, are added. Advantageously, quantities of initiator and monomer are chosen so as to obtain a low polymerisation yield in order to create a very fine layer 23 of polymer on the surface of the nanoparticles 20 (for example from 5 nm to 10 nm). Low denotes a polymerisation yield less than 50%, and preferably less than 25%, preferentially less than 20%, for example of the order of 10%. The quantity of monomers consumed is determined by the polymerisation yield.

According to a first alternative embodiment, steps c) and d) are carried out simultaneously.

According to a further alternative embodiment, the method successively includes steps c), d) and c).

According to a further embodiment, step c) is carried out before step b).

When the polymer precursors are contacted with the polymerisation initiator, polymerisation is initiated.

The polymerisation is a radical polymerisation. This is initiated by the entry into the micelle of a (hydrophilic) oligo-radical previously formed in aqueous phase which will induce progressive consumption of the (hydrophobic) monomers stored in the dispersing phase (herein oil), until the micelle is saturated.

Conditions suitable for reacting the polymerisation initiator are set up, typically by raising the temperature and/or by sonication.

For example, the polymerisation is performed by heating the emulsion to a temperature from 40° C. to 80° C., preferably from 50° C. to 80° C., and preferentially from 60° C. to 70° C. These temperature ranges may be adapted according to the temperature at which the polymerisation initiator becomes reactive.

The polymerisation step generally lasts from some minutes to some tens of minutes, for example about 20 minutes. This step may be performed under ultrasound using a sonication probe.

Following the polymerisation step, the droplets of the emulsion are converted into solid elements dispersed in the organic phase. “Dispersion” denotes a stable suspension of solid elements, preferably individualised and not agglomerated, in a liquid continuous phase. The elements have a mean size equivalent to the mean size of the droplets of the emulsion from which they originate.

Following the polymerisation step, a “wash” (precipitation/dilution sequence) is advantageously carried out to remove the unused reaction products and retrieve the latex.

A centrifugation step is, advantageously, carried out to separate the metal/C/polymer nanoparticles from the polymer beads.

A ready-to-use composite material (colloid or powder) is obtained.

### Illustrative and Non-Limiting Examples of an Embodiment

Ni/graphene/PS nanoparticles 20 were prepared with a miniemulsion method. High-molecular-weight polystyrene (PS) is added to a solution containing these nanoparticles.

On a silicon substrate 100, suitable for being thinned to the desired thickness to meet the specifications of an extra-flat capacitor (≤100 μm), a first gold electrode 101 is formed, by vacuum evaporation.

The solution containing the nanoparticles and the PS is then deposited by spin-coating. The thickness of the dielectric film 40 may be adjusted between 0.05 μm and 50 μm. It is, for example, 2 μm for a deposition at 1000 rpm. The second electrode 102 is then formed so as to obtain a planar capacitor (2D).

The capacitor has a statistically homogeneous distribution of Ni/C/polymer nanoparticles 20 sorted by size in the Polystyrene host matrix 50.

These conditions satisfy the increase in the permittivity of the host polymer envisaged by the percolation theory.

1. Metal-polymer capacitor comprising a dielectric film disposed between a first electrode and a second electrode, wherein the dielectric film comprises:
core-shell structure nanoparticles, the core of the nanoparticles being metallic and the shell comprising a first layer made of an inorganic carbonaceous material and a second layer made of a first polymer material, the ratio between the maximum diameter of the nanoparticles and the minimum diameter of the nanoparticles being less than or equal to 5, preferably less than or equal to 3,
a matrix wherein the nanoparticles are dispersed, the matrix being a mineral matrix or a matrix made of a second polymer material,
the volume percentage of nanoparticles in the dielectric film ranging from 0.01% to 10%.

2. Capacitor according to claim 1, wherein the inorganic carbonaceous material is organised 2D carbon.

3. Capacitor according to claim 1, wherein the core of the nanoparticles is made of cobalt, iron, nickel, copper, silver or gold.

4. Capacitor according to claim 1, wherein the first polymer material is chosen among polystyrene, poly(methyl methacrylate), polyurethane, a polyacrylic, polypropylene, a polyimide, polyetherimide and a polymer having a pyrene group.

5. Capacitor according to claim 1, wherein the dielectric film comprises electrically insulating nanoparticles.

6. Capacitor according to claim 5, wherein the electrically insulating nanoparticles are made of metal oxide, for example of barium and/or strontium oxide, silicon carbide, diamond or hexagonal boron nitride.

7. Capacitor according to claim 5, wherein the electrically insulating nanoparticles are in the shell of the nanoparticles.

8. Capacitor according to claim 5, wherein the electrically insulating nanoparticles are in the polymeric matrix.

9. Capacitor according to claim 8, wherein the dielectric film comprises an alternation of core/shell structure and electrically insulating nanoparticles.

10. Capacitor according to claim 8, wherein the core/shell structure nanoparticles and the electrically insulating nanoparticles are dispersed randomly in the polymeric matrix.

11. Capacitor according to claim 1, wherein the second polymer material is chosen among polystyrene, polyethylene terephthalate, cellulose acetate, polycarbonate, polypropylene, polyethylene, a polyamide, a polysiloxane, a polysulphone, a polyester, a polyetheretherketone, a polyetherimide and an epoxide.

12. Capacitor according to claim 1, wherein the second polymer material comprises groups photosensitive to ultraviolet rays.

13. Capacitor according to claim 1, wherein the ratio between the maximum diameter of the nanoparticles and the minimum diameter of the nanoparticles is less than 1.5.

14. Capacitor according to claim 1, wherein the ratio between the maximum diameter of the nanoparticles and the minimum diameter of the nanoparticles is less than 1.2.

15. Capacitor according to claim 1, wherein the volume percentage of nanoparticles in the dielectric film ranging from 0.01% to 5%.

16. Capacitor according to claim 1, wherein the volume percentage of nanoparticles in the dielectric film ranging from 0.1% to 2%.

17. Method for manufacturing a metal-polymer capacitor as defined in claim 1, comprising the following steps:
i. Providing a solution containing:
a solvent,
the core-shell structure nanoparticles, the core of the nanoparticles being metallic and the shell comprising a first layer made of a carbonaceous material and a second layer made of a first polymer material, the ratio between the maximum diameter of the nanoparticles and the minimum diameter of the nanoparticles being less than or equal to 5,
the dissolved second polymer material or the precursors of the second polymer material,
ii. optionally, polymerising the precursors of the second polymer material,
iii. depositing the solution on an electrode.

18. Method according to claim 17, wherein the core/shell structure nanoparticles provided in step i) are obtained according to the following steps:
a) Preparing a water-in-oil emulsion comprising droplets of an aqueous phase, dispersed in an organic phase,
b) Adding nanoparticles comprising a metallic core coated with a shell of carbonaceous material, whereby nanoparticles trapped in the droplets are obtained,
c) Adding precursor monomers of the first polymer material, and
d) Adding a polymerisation initiator,
Contacting the precursor monomers of the first polymer material and the polymerisation initiator resulting in polymerisation of the monomers, whereby nanoparticles, coated with a layer of the first polymer material, dispersed in the organic phase, are obtained.

19. Method according to claim 17, wherein electrically insulating nanoparticles are added during step i).

20. Method according to claim 17, wherein electrically insulating nanoparticles are added during step a), b) or c).
